(19) United States
(12) Patent Application Publication
(10) Pub. No.: US 2011/0191522 A1
(43) Pub. Date: Aug. 4, 2011

(54) Managing Metadata and Page Replacement in a Persistent Cache in Flash Memory

(76) Inventors: Michael N. Condict, Lexington, MA (US); Stephen M. Byan, Littleton, MA (US); James F. Lentini, Woburn, MA (US)

(21) Appl. No.: 12/698,926

(22) Filed: Feb. 2, 2010

(51) Int. Cl. G06F 12/00; G06F 12/08

(52) U.S. Cl. 711/103; 711/141; 711/104; 711/E12.001; 711/E12.008; 711/E12.026

(57) ABSTRACT

A persistent cache is implemented in a flash memory that includes a journal section that stores metadata and a low frequency section and a high frequency section that store data entries. Writing new metadata to the persistent cache includes sequentially advancing to a next sector containing an invalid metadata entry, saving a working copy of the sector in RAM, writing metadata corresponding to one or more new data entries in the working copy, and overwriting the sector in the flash memory containing the invalid entry with the working copy. Writes to the low frequency and high frequency sections occur sequentially in the current locations of a low frequency section pointer and a high frequency section pointer, respectively. In a persistent cache, the reconstruction of a non-persistent cache utilizes the metadata entry that has the most recent timestamp.

### FIELD OF THE INVENTION

At least one embodiment of the present invention pertains to data storage systems, and more particularly, to a persistent cache implemented in flash memory that uses mostly sequential writes to the cache memory while maintaining a high hit-rate in the cache.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2009, NetApp, Inc., All Rights Reserved.

### BACKGROUND

Various forms of network-based storage systems exist today. These forms include network attached storage (NAS), storage area networks (SANs), and others. Network storage systems are commonly used for a variety of purposes, such as providing multiple users with access to shared data, backing up critical data (e.g., by data minoring), etc.

A network-based storage system typically includes at least one storage server, which is a processing system configured to store and retrieve data on behalf of one or more client processing systems (“clients”). In the context of NAS, a storage server may be a file server, which is sometimes called a “filer”. A filer operates on behalf of one or more clients to store and manage shared files. The files may be stored in a storage system that includes one or more arrays of mass storage devices, such as magnetic or optical disks or tapes, by using a storage scheme such as Redundant Array of Inexpensive Disks (“RAID”). Additionally, the mass storage devices in each array may be organized into one or more separate RAID groups.

In a SAN context, a storage server provides clients with block-level access to stored data, rather than file-level access. Some storage servers are capable of providing clients with both file-level access and block-level access, such as certain filers made by NetApp, Inc. (NetApp®) of Sunnyvale, Calif.

Clients may maintain a cache including copies of frequently accessed data stored by a file server. As a result, the clients can quickly access the copies of the data rather than waiting for a request to be processed by the server. Flash memory, for instance, is a form of non-volatile storage that is beginning to appear in server-class computers and systems. Flash memory is non-volatile and, therefore, remains unchanged when the device containing the flash memory is rebooted, or if power is lost. Accordingly, a flash cache provides a benefit of being persistent across reboots and power failures.

A persistent cache, however, writes cache metadata, not just the I/O data itself, to the flash memory regularly. The metadata in a cache can have several purposes, including keeping track of which I/O data entries in the cache represent the contents of which blocks on the primary storage (e.g., in a mass storage device/array managed by a server). Since flash memory falls between random access memory (“RAM”) and hard-disk drives in speed and cost-per-gigabyte, effective disk input/output (“I/O”) performance can be increased by implementing a second-level I/O cache in the flash memory, in addition to the first-level I/O cache that is implemented in RAM. A flash cache, however, poses a unique problem in that random writes to flash memory can be an order of magnitude slower than sequential writes. In typical caching algorithms, linked lists and other data structures that utilize random writes are used, which would be highly inefficient if implemented on flash memory. For example, least recently used (“LRU”) based policies track the “age” of entries in a cache by, every time an entry is accessed, increasing the age of all entries that were not accessed. If an entry is to be evicted or overwritten, the entry with the highest age (i.e., the least recently used entry) will be evicted or overwritten. This policy is focused on frequency of use, not physical location, and, therefore, results in writing data into the cache randomly, not sequentially.

Writing in a purely sequential fashion, however, may result in a significant sacrifice in the hit rate of a cache. The “hit rate” of a cache describes how often a searched-for entry is found in the cache. Accordingly, it is desirable to keep the most frequently used entries in the cache to ensure a high hit rate. If entries were evicted or overwritten in a purely sequential manner, however, the frequency of use of particular entries will be ignored. As a result, items that are frequently accessed are as likely to be evicted or overwritten as items that are less frequently accessed and the hit rate would decrease.

### SUMMARY

The persistent cache described herein is implemented in a flash memory that includes a journal section that stores metadata as well as a low frequency section and a high frequency section that store data entries. Writing new metadata to the persistent cache includes sequentially advancing to a next sector containing an invalid metadata entry, saving a working copy of the sector in RAM, writing metadata corresponding to one or more new data entries in the working copy, and overwriting the sector in the flash memory containing the invalid entry with the working copy. Writes to the low frequency and high frequency sections occur sequentially in the current locations of a low frequency section pointer and a high frequency section pointer, respectively. When two metadata entries are associated with a single location in primary storage, the reconstruction of a non-persistent cache utilizes the metadata entry that has the most recent timestamp.

Embodiments of the present invention are described in conjunction with systems, clients, servers, methods, and computer-readable media of varying scope. In addition to the aspects of the embodiments described in this summary, further aspects of embodiments of the invention will become apparent by reference to the drawings and by reading the detailed description that follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates a storage network environment, which includes a storage client in which a persistent cache may be implemented;

FIG. 2 shows an example of the hardware architecture of the storage client in which a persistent cache may be implemented;

FIG. 3 shows an exemplary layout of a persistent cache in a flash memory and the corresponding primary storage;

FIG. 4 shows an exemplary layout of a persistent cache in a flash memory that employs deduplication and the corresponding primary storage;

FIG. 5 shows an exemplary flow chart for a method of logging metadata in a persistent cache;

FIG. 6 shows an exemplary flow chart for a method of determining the validity of metadata in a persistent cache;

FIG. 7 shows an exemplary flow chart for a method of page replacement in a persistent cache;

FIG. 8 illustrates an exemplary page replacement operation in a persistent cache;

FIG. 9 shows an exemplary flow chart for a method of employing deduplication in a persistent cache; and

FIG. 10 shows an exemplary flow chart for a method for reconstructing a working cache in RAM from the persistent cache.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims. References in this specification to “an embodiment”, “one embodiment”, or the like, mean that the particular feature, structure or characteristic being described is included in at least one embodiment of the present invention. However, occurrences of such phrases in this specification do not necessarily all refer to the same embodiment.

The persistent cache described herein consists of several alternate mechanisms that use mostly sequential writes of data and metadata to the cache memory, while still maintaining a high hit rate in the cache. The hit rate refers to the percentage of operations that are targeted at a data entry already in the persistent cache and is a measure of a cache's effectiveness in reducing input to and output from the primary storage. The persistent cache is implemented in a flash memory that includes a journal section that stores metadata as well as a low frequency section and a high frequency section that store data entries. Writing new metadata to the persistent cache includes sequentially advancing to a next sector containing an invalid metadata entry, saving a working copy of the sector in RAM, writing metadata corresponding to one or more new data entries in the working copy, and overwriting the sector in the flash memory containing the invalid entry with the working copy. Writes to the low frequency and high frequency sections occur sequentially in the current locations of a low frequency section pointer and a high frequency section pointer, respectively. When two metadata entries are associated with a single location in primary storage, the reconstruction of a non-persistent cache utilizes the metadata entry that has the most recent timestamp.

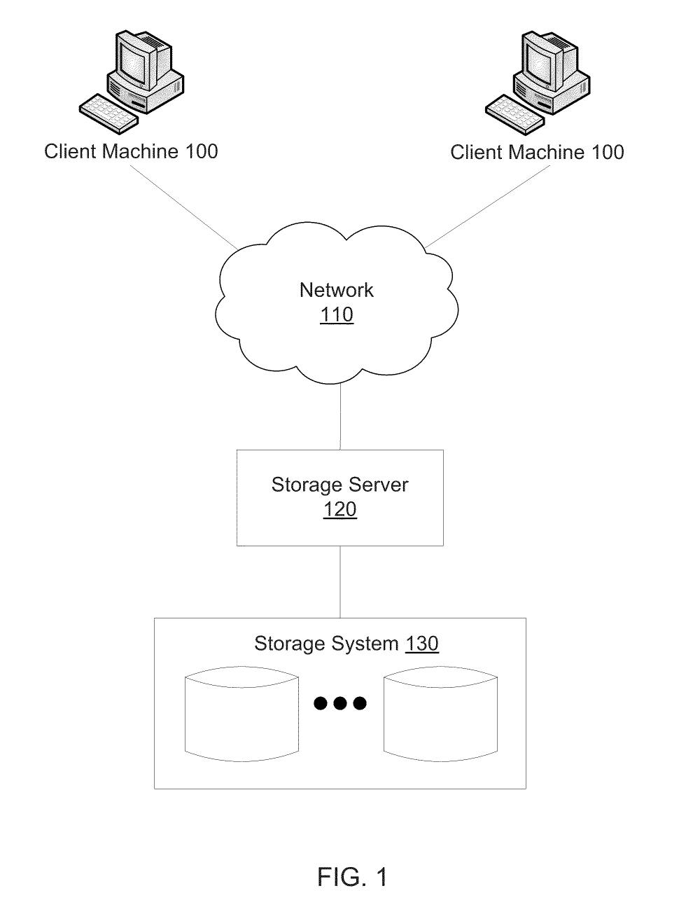

FIG. 1 shows an exemplary network environment that incorporates one or more client machines 100 (hereinafter “clients”), in which the persistent cache can be implemented. For one embodiment, I/O requests directed to a server are intercepted and the persistent cache within the client is searched for the target data. If the data is found in the persistent cache, it may be provided in less time than needed for a server to access and return the data. Otherwise, the request is forwarded to the server and the cache may be updated accordingly (e.g., the data, once returned by the server, may be added to the cache according to a page replacement method described below).

For one embodiment, the persistent cache is implemented within a hypervisor/virtual machine environment. A hypervisor, also referred to as a virtual machine monitor, is a software layer that allows a processing system to run multiple virtual machines (e.g., different operating systems, different instances of the same operating system, or other software implementations that appear as “different machines” within a single computer). The hypervisor software layer resides between the virtual machines and the hardware and/or primary operating system of a machine. The hypervisor may allow the sharing of the underlying physical machine resources (e.g., disk/storage) between different virtual machines (which may result in virtual disks for each of the virtual machines).

For one embodiment, the client machine 100 operates as multiple virtual machines and the persistent cache is implemented by the hypervisor software layer that provides the virtualization. Accordingly, if the persistent cache is implemented within the hypervisor layer that controls the implementation of the various virtual machines, only a single instance of the persistent cache is used for the multiple virtual machines.

Additionally, an embodiment of the persistent cache can support deduplication within the client 100. Deduplication eliminates redundant copies of data that is utilized/stored by multiple virtual machines and allows the virtual machines to utilize the single copy. Indexing of the data, however, is still retained. As a result, deduplication is able to reduce the storage capacity since primarily only the unique data is stored. For example, a system containing 100 virtual machines might contain 100 instances of the same one megabyte (MB) file. If all 100 instances are saved, 100 MB storage space is used (simplistically). With data deduplication, only one instance of the file is actually stored and each subsequent instance is just referenced back to the one saved copy. In this example, a 100 MB storage demand could be reduced to only 1 MB. Additionally, if the persistent cache is implemented at the hypervisor level, it will be compatible with the multiple virtual machines even if they each run different operating systems.

Embodiments of the persistent cache can also be adapted for use in a storage server 120 or other types of storage systems, such as storage servers that provide clients with block-level access to stored data as well as processing systems other than storage servers. In an additional embodiment, the persistent cache can be implemented in other computer processing systems and is not limited to the client/server implementation described above.

Each of the clients 100 may be, for example, a conventional personal computer (PC), server-class computer, workstation, or the like. Implementing a persistent cache, the clients 100 can maintain and reconstruct cached data and corresponding metadata after a power failure or reboot. For one embodiment, the persistent cache is implemented in flash memory. Accordingly, the implementation of the persistent cache utilizes the speed of writing to flash memory sequentially (as opposed to randomly) while maintaining a high hit rate as will be explained in greater detail below.

The clients 100 are coupled to the storage server 120 through a network 110. The network 110 may be, for example, a local area network (LAN), a wide area network (WAN), a global area network (GAN), etc., such as the Internet, a Fibre Channel fabric, or a combination of such networks.

The storage server 120 is further coupled to a storage system 130, which includes a set of mass storage devices. The mass storage devices in the storage system 130 may be, for example, conventional magnetic disks, solid-state disks (SSD), magneto-optical (MO) storage, or any other type of non-volatile storage devices suitable for storing large quantities of data. The storage server 120 manages the storage system 130, for example, by receiving and responding to various read and write requests from the client(s) 100, directed to data stored in or to be stored in the storage system 130.

Although illustrated as a self-contained element, the storage server 120 may have a distributed architecture (e.g., multiple storage servers 120 cooperating or otherwise sharing the task of managing a storage system). In this way, all of the storage systems can form a single storage pool, to which any client of any of the storage servers has access. Additionally, it will be readily apparent that input/output devices, such as a keyboard, a pointing device, and a display, may be coupled to the storage server 120. These conventional features have not been illustrated for the sake of clarity.

RAID is a data storage scheme that divides and replicates data among multiple hard disk drives. Redundant (“parity”) data is stored to allow problems to be detected and possibly fixed. Data striping is the technique of segmenting logically sequential data, such as a single file, so that segments can be assigned to multiple physical devices/hard drives. For example, if one were to configure a hardware-based RAID-5 volume using three 250 GB hard drives (two drives for data, and one for parity), the operating system would be presented with a single 500 GB volume and the exemplary single file may be stored across the two data drives.

It will be appreciated that certain embodiments of the present invention may be implemented with solid-state memories including flash storage devices constituting storage system 130. For example, storage system 130 may be operative with non-volatile, solid-state NAND flash devices which are block-oriented devices having good random read performance, i.e., random read operations to flash devices are substantially faster than random write operations. Data stored on a flash device is accessed (e.g., via read and write operations) in units of pages, which in the present embodiment are 4 kB in size, although other page sizes (e.g., 2 kB) may also be used.

When the flash storage devices are organized as one or more parity groups in a RAID array, the data is stored as stripes of blocks within the parity groups, wherein a stripe may constitute similarly located flash pages across the flash devices. For example, a stripe may span a first page 0 on flash device 0, a second page 0 on flash device 1, etc. across the entire parity group with parity being distributed among the pages of the devices. Note that other RAID group arrangements are possible, such as providing a RAID scheme wherein every predetermined (e.g., 8th) block in a file is a parity block. Embodiments of the invention, however, can be implemented in both RAID and non-RAID environments.

A “block” or “data block,” as the term is used herein, is a contiguous set of data of a known length starting at a particular offset value or address within storage system 130. A block may also be copied or stored in RAM, the persistent cache, or another storage medium within the clients 100 or the storage server 120. For certain embodiments, blocks contain 4 kilobytes of data and/or metadata. In other embodiments, blocks can be of a different size or sizes.

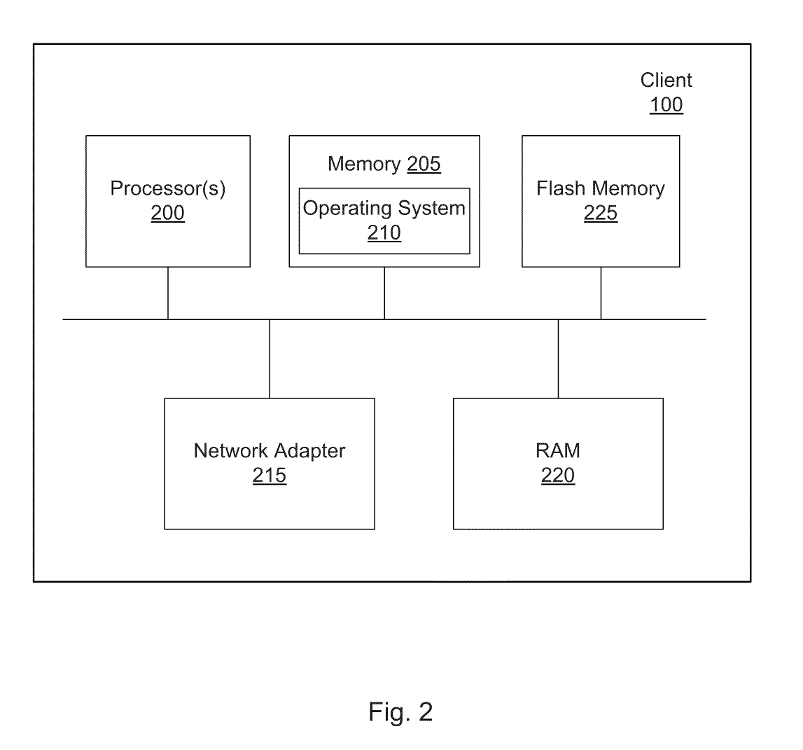

FIG. 2 is a block diagram showing an example of the architecture of a client machine 100 at a high level. Certain standard and well-known components, which are not germane to the present invention, are not shown. The client machine 100 includes one or more processors 200 and memory 205 coupled to a bus system. The bus system shown in FIG. 2 is an abstraction that represents any one or more separate physical buses and/or point-to-point connections, connected by appropriate bridges, adapters and/or controllers.

The processors 200 are the central processing units (CPUs) of the client machine 100 and, thus, control its overall operation. The processors 200 accomplish this by executing software stored in memory 205.

The memory 205 includes the main memory of the client machine 100. The memory 205 stores, among other things, the client machine's operating system 210, which, according to one embodiment, can implement a persistent cache as described herein. For one embodiment, the operating system 210 implements a virtual machine hypervisor.

The flash memory 225 is also coupled to the bus system. For one embodiment, the persistent cache is a second-level cache implemented in the flash memory 225, in addition to a first-level cache implemented in RAM in a section of the memory 205, in RAM 220, or elsewhere within the client machine 100. Embodiments of flash memory 225 may include, for instance, NAND flash or NOR flash memories.

Also connected to the processors 200 through the bus system is a network adapter 215 The network adapter 215 provides the client machine 100 with the ability to communicate with remote devices, such as the storage server 120, over a network.

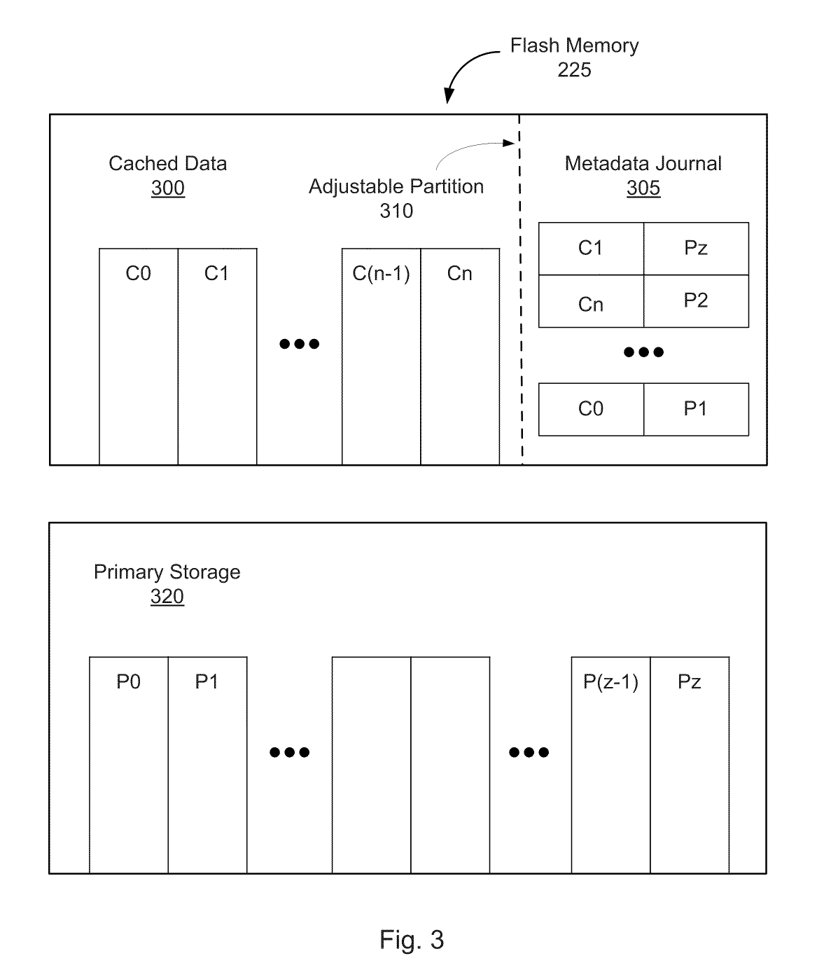

FIG. 3 shows an exemplary layout of a persistent cache in a flash memory 225 and the corresponding primary storage 320. For one embodiment, the primary storage 320 represents part or all of storage system 130. Alternatively, the primary storage 320 is located within the storage server 120 (or within a client 100).

The persistent cache, as implemented within the flash memory 225, stores a set of data entries C0-Cn (cached data 300) that are duplicates of a portion of the original data entries P0-Pz stored within the primary storage 320 (i.e., z>n). Read and write operations directed to the original data in primary storage 320 typically results in longer access times, compared to the cost of accessing the cached data 300.

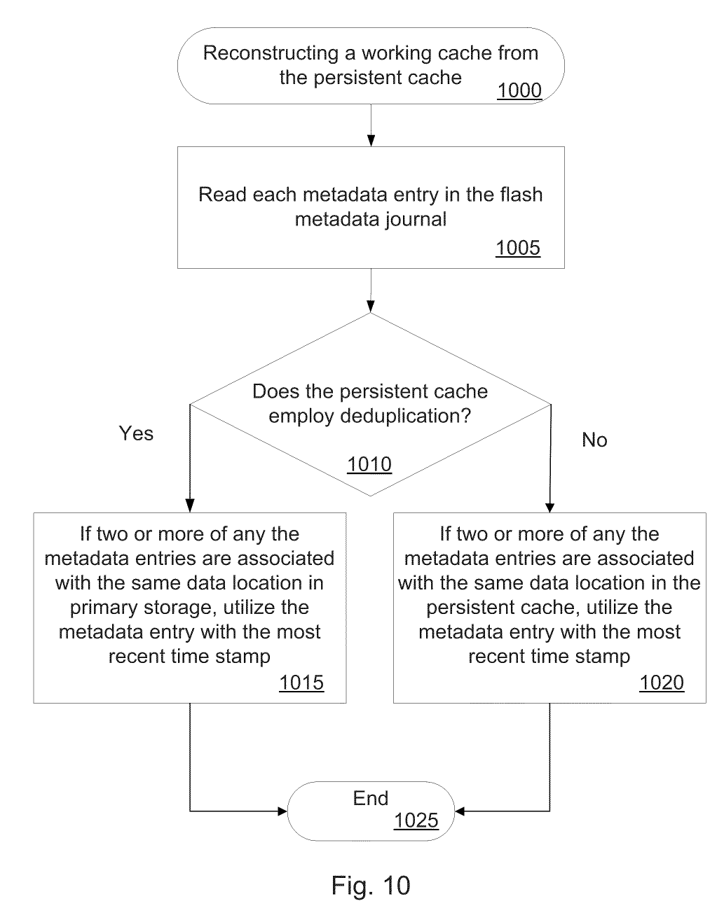

In addition to storing copies of blocks of data from the primary storage 320, the persistent cache stores metadata in a metadata journal 305 for each entry of cached data 300. The metadata may be used to interpret the cached data 300 or to increase performance of the persistent cache. While random-access data structures in RAM may result in better performance for the operational metadata, the metadata journal 305 may be used to reconstruct these random-access data structures in RAM after a reboot or power failure (as will be discussed below with reference to FIG. 10).

Rather than try to maintain linked-lists, hash tables, and other random-access data structures in the flash memory, which may result in very poor performance, the metadata journal 305, for one embodiment, is implemented as a circular buffer/queue in the flash memory 225 and records each change to the cache metadata. A circular buffer is a data structure that uses a single, fixed-size buffer as if it were connected end-to-end. The logical beginning and end of the circular buffer are tracked (e.g., via pointers) and updated as data is added and removed. When the circular buffer is full and a subsequent write is performed, the oldest data may be overwritten (e.g., if invalid, as explained further below).

Exemplary categories of metadata that may be created/used by embodiments described herein and, accordingly, may be present in a cache include an address map, usage statistics, a fingerprint or other deduplication data (note, however, that a fingerprint can be used for more than deduplication), and an indication whether the metadata entry is valid or invalid. An address map is included in each metadata entry recording which block of primary storage it came from, and to which it is written back, if it is modified. Logically, the address map is a set of pairs, with one member of the pair being a primary storage address and the other member being its cache address. For example, the metadata journal 305 includes an address map that indicates block P1 from the primary storage 320 is currently cached at C0 within the persistent cache. The address map changes whenever a block of data is evicted (flushed) from the cache, moved within the cache, and whenever a new block of data representing a currently uncached block of primary storage is inserted into the cache.

Usage statistics record how frequently or how recently each block of cached data has been accessed. The usage statistics may be used to decide which candidate block to evict when space is needed for a newly cached block. It may consist of a timestamp when a cached data entry or metadata is written or otherwise accessed, a frequency count of how often a data entry is accessed, or some other data, depending on the details of the page replacement policy in use.

In a cache that is serving multiple virtual machines running the same operating system and applications (hence each virtual machine having highly similar virtual disk contents), deduplication metadata improves space utilization, and thus increases the effectiveness of the cache, by allowing the cache to store only one copy of blocks that are from different primary storage addresses but have the same contents. For one embodiment, deduplication metadata includes a fingerprint for each cached block of data. The fingerprint is a sequence of bytes whose length is, for example, between 4 and 32 bytes. A fingerprint is an identifier computed from the contents of each block (e.g., via a hash function, checksum, etc.) in such a manner that if two data blocks have the same fingerprint, they almost certainly have the same contents. When a persistent cache is employing deduplication, it records changes to the deduplication fingerprint at the same time it updates the contents of blocks.

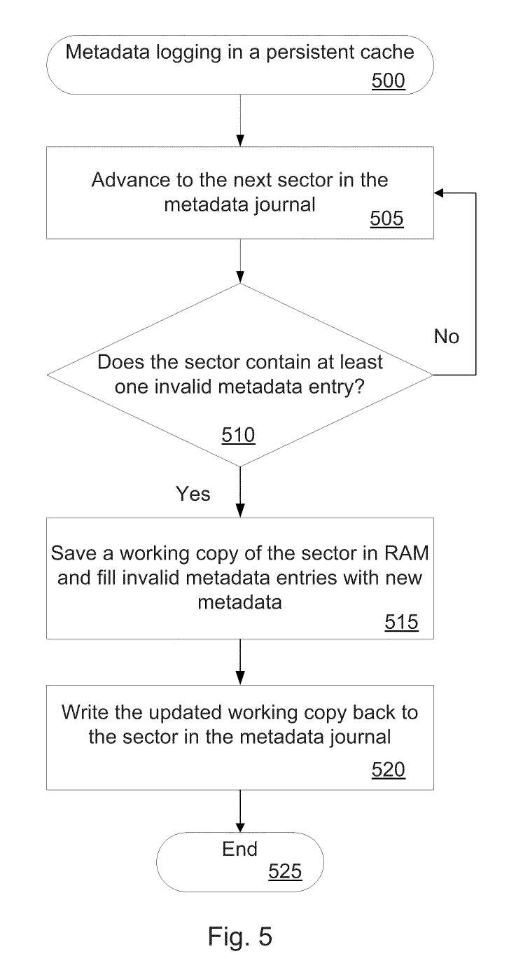

For one embodiment, the cache has a defined memory size and, as a result, there is a limit to the number of metadata entries and cached data entries that may be stored in the cache—i.e., a set of addresses/storage locations in the cache memory is divided between the cached data and the metadata journal. For example, the data is stored in one contiguous portion of the flash memory and the metadata is stored in another contiguous portion of the flash memory, each designated by start and end addresses, pointers, etc. As described above, the metadata journal 305 is circular in that it is written sequentially until the end is reached, and then overwriting continues at the beginning. In order for the flash memory 225 to contain a complete and up-to-date record of the current metadata, the circular updating of the metadata journal 305 does not overwrite valid metadata entries (e.g., by testing the validity of the metadata entries of the current sector, it is determined which entries are to be overwritten). Additionally, maintaining a number of metadata entries in the journal 305 to be somewhat larger than the number of valid entries allows embodiments of the persistent cache to quickly and mostly sequentially append new entries to the journal 305 by overwriting a sector that has some invalid entries (described in greater detail below with reference to FIG. 5).

Accordingly, the metadata journal 305 is defined (e.g., automatically by the client 100, operating system, hypervisor, a software plug-in, etc.) to be of a size that is a multiple of the cached data 300 portion of the flash memory 225. For one embodiment, the metadata journal 305 is two to three times larger than the number of valid metadata entries—e.g., the number of operational metadata entries in RAM. This means that on average, less than half of the entries in the metadata journal would be up-to-date entries that have not been superseded by a more recent version of the same entry, or rendered obsolete by a block having been evicted from the cache.

For one embodiment, the size of each portion of the cache is adjusted based upon need and the logical demarcation between the two, ie., a boundary or partition, is moved. The limit on the total number of metadata entries in the metadata journal 305 may be adjusted randomly, periodically, or in response to the metadata entries exceeding a limit and according to the multiple of valid metadata entries at the time of the adjustment (as determined by the client device 100). This determination results in a floating boundary or adjustable partition 310 between the two categories of storage in the flash memory 225—e.g., by changing the addresses, pointers, or other designations for the start and end of the cached data and metadata portions of the flash memory 225. For example, if the number of valid metadata entries exceeds one half of the current number that can fit in the metadata journal 305, the metadata journal 305 is enlarged by the size of one cached block. This may result in evicting the cached block that is sequentially close to the space used for the metadata journal 305, and moving the adjustable partition 310 over that block, resulting in one less cacheable data block, and an increase in the number of metadata entries. Conversely, if the space in the metadata journal 305, for example, becomes more than 3 times as large as the number of valid metadata entries, the metadata is reduced by the size of one data block: the adjustable partition 310 between the metadata and the cached data 300 is moved by the size of one data block in the direction of the metadata, resulting in one more cacheable data block and less metadata entries. Any valid metadata entries in the portion of the metadata journal 305 that is being eliminated are copied to other empty or invalid locations in the metadata journal 305.

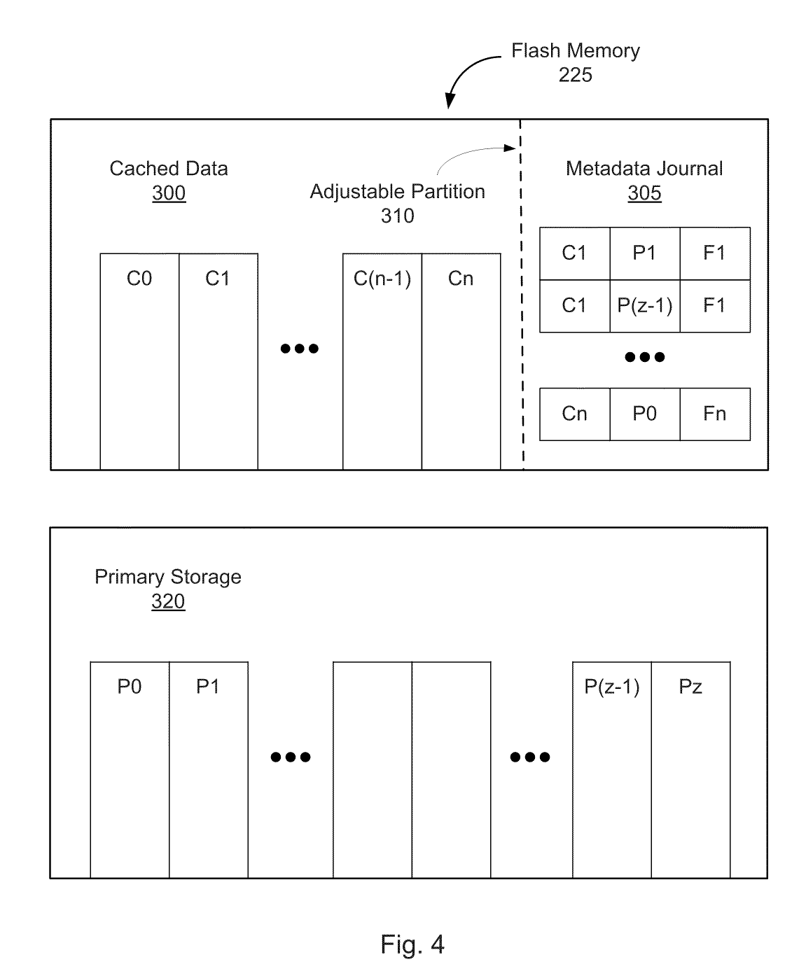

FIG. 4 shows an exemplary layout of a persistent cache in a flash memory 225 that employs deduplication and the corresponding primary storage 320. Implementation of a persistent, deduplicating cache will employ many of the same components as described above with reference to FIG. 3. In implementing a deduplicating cache, however, multiple different primary storage locations that contain the same data may be stored at a single location in the cache. Logically, this means that the address map is not a one-to-one relation, but rather is many-to-one. This has implications for how the deduplication metadata is stored and updated. While the deduplicating cache contains only n blocks of cached data 300, and hence n fingerprint values, it may cache more than n copies of primary storage locations if some of the primary storage blocks have identical contents and are only cached once. For example, P1 and P(z−1) have identical contents and are cached at cache location C1, each with their own metadata entries including an address map and fingerprint F1.

FIG. 5 shows an exemplary flow chart for a method 500 of logging metadata in a persistent cache. At block 505, the method 500 advances to the next sector in the metadata journal 305. For one embodiment, sequential traversal of the metadata journal 305 is tracked by a current location pointer that is advanced one sector at a time until it reaches the end of the journal 305 and returns to the beginning of the journal 305. Alternatively, the method 500 tracks a current sector in the metadata journal 305 by saving and updating a current location in RAM or utilizing another, equivalent data structure (e.g., a pointer).

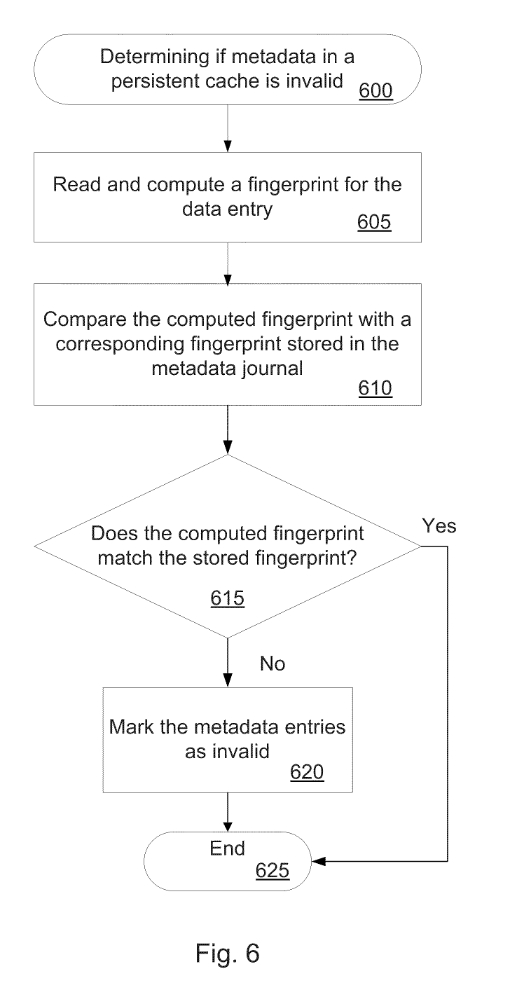

At block 510, the method 500 determines if the current sector contains any invalid metadata entries. For one embodiment, the method 500 compares the metadata entries in the current sector to their counterpart metadata entries in the operational version of the cache metadata in RAM. For one embodiment, the metadata entries in the current sector include validity indicators or flags. The validity of metadata entries in the metadata journal 305 may be set as a result of an eviction or according the method 600 described below with reference to FIG. 6.

If the current sector in the metadata journal 305 contains only valid entries, the method 500 leaves that sector unchanged and returns to block 505. Otherwise, at block 515, the method 500 saves a working copy of the current sector in RAM. For one embodiment, the flash memory 225 includes a small subsection of RAM for this purpose. Alternatively, the method 500 utilizes RAM elsewhere within the client machine 100. The method 500 proceeds to overwrite the invalid entries (including empty entries) in the working copy with new metadata. While the working copy of the sector is being filled, any newly loaded data blocks associated with these I/O operations are saved in RAM. Although the page replacement policies (described below) assign these data blocks to specific cache locations, the data blocks may not yet be written to cache locations on the flash memory. If the method 500 encounters two write operations on the same primary storage address while the current sector is being filled with new metadata, only the latest version of the data block is saved and the previous version is overwritten or discarded.

At block 520, the method 500 writes the updated working copy back to the current sector of the metadata journal 305. For one embodiment, the method 500 waits until the sector contains only valid entries. Alternatively, the method 500 overwrites the current sector in the flash memory 225 after a defined number of entries are updated. In another embodiment, the method 500 copies multiple sectors to RAM and overwrites them after filling the multiple sectors with valid metadata entries.

For one embodiment, each metadata entry includes a timestamp indicating when the entry was requested and/or recorded. Alternatively, a single timestamp is used for the entire sector. Additionally, for one embodiment, each metadata entry includes a fingerprint of its corresponding data entry. For example, a fingerprint may be computed by applying a fingerprint function such as a checksum or hashing algorithm to the data entry. The resulting fingerprint is a bit-sequence, e.g., between 32 and 64 bits in length, which is computed from the contents of a cached block in such a way that two different block contents are extremely unlikely to result in the same fingerprint. The computation of a fingerprint uses only a few CPU instructions per byte of data.

Without the use of a timestamp or fingerprint, the order in which the different items in a persistent cache are modified is chosen so that if the caching device shuts down unexpectedly after any one modification, the cache is still useable, and its contents are consistent with the master copy of the data on the primary storage server. The use of timestamps and/or fingerprints, however, allow for there to be flexibility in the order of modifications to the metadata and corresponding data entries, as well as the time between the two sets of modifications, because this metadata can be used to determine whether or not the metadata and data entry is to be treated as valid.

For example, in the absence of a fingerprint, the metadata is first modified to indicate that there is no valid block at a particular cache location C0. The data from the primary storage 320 location P1 can then be copied over the existing data at location C0. The address map in the metadata is then updated to indicate that location C0 is now caching a copy of P1. A crash or power failure occurring anywhere during this process leaves the cache correct and consistent, assuming that the metadata updates are atomic (they either entirely succeed or have no effect).

With the presence of a fingerprint in the metadata, however, the order in which the data and the metadata are written does not matter because the correctness is protected by the fingerprint. For example, an update to the metadata to indicate that P1 is now cached at location C1, and includes a fingerprint F1 and the contents of P1 are then copied to cache location C1. These two write operations can be done in any order, or in parallel, and, if a crash or power failure happens while they are in progress, the cache remains consistent (again, assuming the write operations either entirely succeed or have no effect). This is because the fingerprint in the metadata entry will almost certainly not match the contents of the cached data that is used to compute the fingerprint, until both writes complete successfully. Thus on a restart, it will be detectable that there is something wrong with either the metadata entry or the cached data block to which it refers, and both can be considered invalid (e.g., the cache location will be considered empty).

The presence of a timestamp in the metadata enables an embodiment of the invention to determine, when multiple metadata entries refer to the same cache location, which of the multiple metadata entries is valid. For example, if P1 is cached at location C1 and then later evicted and P2 is then cached at C1. If P2 happens to have the same contents as P1, the invalid metadata entry indicating that P1 is cached at C1 would have a fingerprint that agrees with a fingerprint for the currently cached contents at C1. Additionally, if the contents of P1 were subsequently changed and cached at C2, the fingerprint in the metadata for C2 would also match a fingerprint of the cached contents of C2. In other words, on restart, comparing the fingerprint of cached locations C1 and C2 could lead to two different metadata entries for P1 matching two different cache locations and both appearing to be valid. For one embodiment, the metadata with the most recent timestamp (i.e., the metadata entry stating that P1 is cached at C2) would be considered valid. Alternatively, an embodiment compares the fingerprint of the P1 with the fingerprints in the metadata journal 305 or compares the data content stored at P1 with the data cached at C1 and C2 to determine which metadata entry is valid. The use of timestamps and fingerprints are further described below with reference to FIGS. 6 and 10.

Flash memory devices often use a disk-like interface, i.e., one in which all read and write operations are expressed in units of sectors. A sector is typically 512 bytes, but embodiments of the present invention may define a sector to be larger or smaller than 512 bytes. A sector is much larger than a single metadata entry, which may be on the order of 32 bytes in length. Thus, the method 500 of logging metadata in a persistent cache employs a batching technique to write a plurality of metadata entries to the flash memory 225 with a single write operation. For example, the method 500 may batch up changes (e.g., in RAM) until there are enough to fill a complete sector in the flash memory 225 and write these changes in a single operation. Alternatively, the method 500 batches up metadata entries for multiple adjacent sectors.

Each I/O operation that passes through the persistent cache results in the updating of a metadata journal entry, if only to record the new usage statistics, in the case where the data block is already cached. If a certain block is frequently used, its metadata entry will also be frequently updated. Thus the performance of appending metadata changes can be greatly improved by collecting together many metadata changes, coalescing multiple changes to the same metadata entries, and writing out the remaining changes together to the flash memory 225, in a single I/O operation. The batch update of metadata is also synchronized with the updating of the corresponding data blocks of the cache.

FIG. 6 shows an exemplary flow chart for a method 600 of determining the validity of metadata in a persistent cache. At block 605, the method reads and computes a fingerprint for the cached data. At block 610, the method 600 compares the computed fingerprint with the corresponding fingerprint stored in the metadata journal 305. For one embodiment, if there are multiple metadata entries that point to the cache location, the method 600 compares the computed fingerprint with the metadata journal entry with the most recent timestamp. At block 615, if the fingerprints match, the cached data is considered valid and the data can be used to satisfy the read operation. If the fingerprints do not match, however, the cached data will be considered invalid at block 620. For one embodiment, the eviction procedure described above will take place upon discovery of an invalid block.

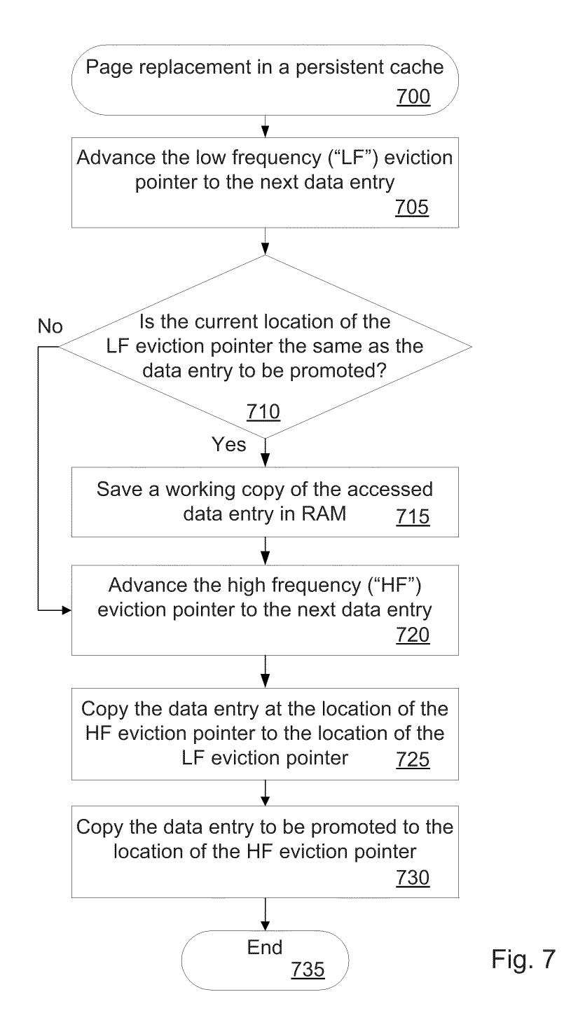

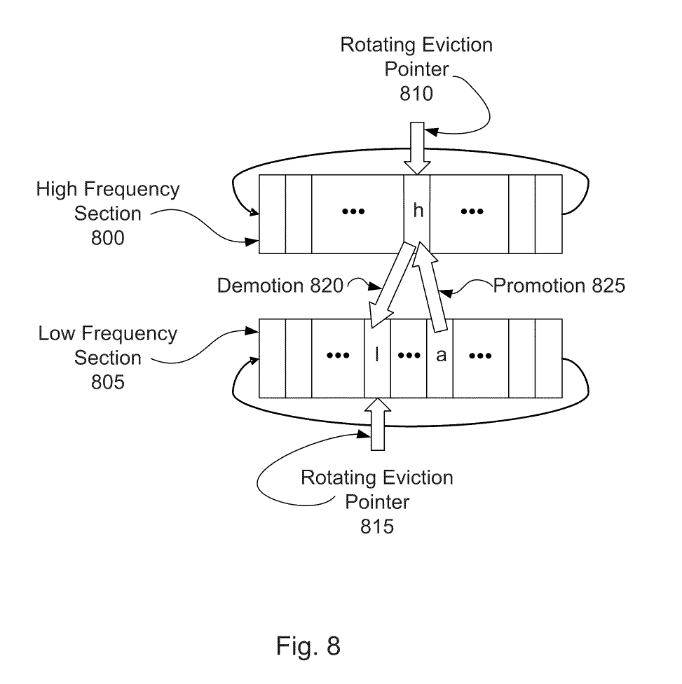

FIG. 7 shows an exemplary flow chart for a method 700 of page replacement in a persistent cache and FIG. 8 illustrates an exemplary page replacement operation in a persistent cache. In particular, FIGS. 7 and 8 illustrate management of a persistent cache when a data entry that is already in the cache is accessed again. General page replacement operations, however, are also discussed with reference to FIG. 8.

The cached data 300 is divided into two sections: a high frequency section 800 and a low frequency section 805. For one embodiment, these two sections are implemented as two separate FIFO's (First In, First Out queues). Fore one embodiment, the FIFO's are implemented as circular queues. Similar to the circular buffer/queue described above, the start and end of each FIFO is tracked (e.g., via pointers) to determine where in the queue data may be inserted and where from the queue data is removed. Once a FIFO is full, data may be removed and data may be inserted (e.g., an overwrite operation) from the same location and the one or more pointers may be moved or “rotated” to the next oldest data location. For one embodiment, the size of these two queues is established by one or more of the client device 100, operating system, hypervisor, software plug-in, a system administrator, etc. For one embodiment, the two FIFO's are equal in size, each comprising half of the space available for I/O data in the flash cache (e.g., as described above with regard to the adjustable partition 310). Alternatively, the sizes of the FIFO's are unequal. The high frequency section 800 is intended to contain mostly data that is frequently accessed and the low frequency section 805 is intended to contain data that is less frequently accessed.

Each data entry section of the persistent cache is, respectively, written in a sequential fashion. When a new block of (uncached) data is to be inserted into the persistent cache, and the cache is full, the next rotating position in the low frequency section 805 is chosen as the insertion point, and whatever block is currently cached there is evicted.

Additionally, whenever a block in the low frequency section 805 is accessed by the storage client, it is promoted to the next rotating position in the high frequency section 800, according to method 700. For one embodiment, the respective rotating positions are tracked using rotating eviction pointers 810 and 815. Alternatively, the rotating positions are tracked by location in RAM or using another data structure.

At block 705, method 700 advances the low frequency eviction pointer 815 to the next data entry (cache location 1). At block 710, the method 700 determines if the current location of the low frequency eviction pointer is the same as the data entry to be promoted. If so, at block 715, the method 700 saves a working copy of the accessed data entry in RAM. Otherwise or subsequently, at block 720, the method 700 advances the high frequency eviction pointer 810 to the next rotating position (cache location h) in the high frequency section 800. At block 725, the method 700 demotes the data entry at the current location of the high frequency eviction pointer 810 (cache location h) by copying it to the next rotating position in the low-frequency FIFO (cache location 1), effectively evicting (overwriting) whatever block is found there. At block 730, the data entry to be promoted (e.g., the block that was accessed at cache location a) is copied to the current position (cache location h) in the high frequency section 800 that was just demoted. The metadata is updated accordingly, to reflect the demotion 820 and promotion 825, including the fact that the former location in the low frequency section 805 where the most recent block was accessed, may now be treated as an empty/invalid cache location (unless it was also cache location a).

Before the cache is full, it may be the case that there is no valid block at the next rotating position 810 in the high-frequency section 800 when a block is accessed in the low-frequency section 805, in which case the block to be promoted is just moved to the high frequency section 800 without a demotion 820. Also, when the low frequency section 805 is not full, it may be the case that no valid block exists at the next rotating position 815 in the low frequency section 805, in which case no block is evicted from the cache when a new one is inserted.

In performing page replacement according to method 700, blocks that are accessed at least one more time after being inserted into the cache (before being evicted) will tend to be found in the high frequency section 800. For one embodiment, two steps are used to evict such a block from the persistent cache. The block is demoted 820 back to the low-frequency section 805 by an access to another block there, which, in turn, gets promoted 825 to the high frequency section 800. If the demoted block is not accessed at all during a full round of rotation of the low frequency eviction pointer 815 through the low frequency section 805, will the demoted block be evicted from the cache. This protects frequently accessed blocks from being evicted, which is desirable in a second-level cache while performing writes in a mostly sequential fashion. For example, policies approximating LFU (eviction of the Least Frequently Used page) generally produce higher hit rates than policies based on LRU (eviction of the Least Recently Used page) in a second-level cache, because most of the temporal locality is removed by the first-level cache. Note that the above-described page replacement policy does not result in perfectly sequential writes to the flash cache. It does, however, result in sequential writes in each half of the data portion of the cache. For example, the writes to the high frequency section 800 are completely sequential within that portion of the flash memory. For some flash memories, their implementation of the virtual to physical address mapping (known as the Flash Translation Layer) will recognize that the access to the flash consists of two sequential streams operating in different parts of the flash, and hence that the writes will be much faster than truly random writes.

Modifications to the cached data 300 and/or the metadata journal 305 include: writing to a cached block, evicting a block from the cache, caching a new block to an empty location, replacing a cached block with a different block (e.g., a combination of eviction and caching a new block, as a single operation), and reading from a cached block. Updating the metadata journal 305 and the cached data 300, for each of these operations occurs as follows. Each reference to updating the metadata journal, below, may be a batched update, one sector at a time, as described above.

Writing a cached block: The cached data block is modified in-place (written/overwritten) with the new data, and a new entry is appended to the metadata journal 305. For one embodiment, the new metadata entry includes an updated fingerprint computed from the new data and/or usage statistics indicating that this block has been accessed. The order in which these two writes are done does not matter because if there is a failure between the two events, the fingerprint stored in the metadata will disagree with the contents of the cached block, and this can be detected on reboot.

Evicting a block from the cache: An entry is appended to the metadata journal 305 specifying that the cache address from which a block is being evicted no longer corresponds to any primary storage address. For one embodiment, this is indicated by using a special reserved value for the primary storage address. Alternatively, a flag is set to mark the metadata entry as invalid. Fingerprint value and usage statistics that may be included with this type of metadata entry are irrelevant and are ignored. For one embodiment, this operation occurs when the cached data block becomes invalid because it has changed in the primary storage 320.

Caching a new block to an empty location: Assume that a block at primary storage at location p, with fingerprint f is being inserted in the cache at address c. A metadata entry containing (p,c) in the address-map entry is appended to the journal. The fingerprint is set to f and its usage statistics are set to indicate that the entry has just been accessed. Also, the new data block is written to location c.

Replacing a cached block with a different block: Assume that cache location c currently contains a copy of the block at primary storage location p1 and it is to be replaced with a copy of the block at primary storage location p2. Assume that f1 is the fingerprint of the block at p1 and f2 is the fingerprint of the block at p2. A metadata entry containing (p2,c) in the address-map entry is appended to the journal. Its fingerprint is set to f2 and its usage statistics are set to indicate that the entry has just been accessed. There is no need to remove the entry containing (p1,c) and f1 from the meta-data journal, because the data block cached at location c can be verified to have the fingerprint f2 not f1 (by subsequently recomputing it from the data). This mismatch between fingerprints (e.g., between the fingerprint of the data block cached location p1 and the metadata entry referencing p1) is a clear indication that the metadata entry containing (p1,c) and f1 is an obsolete entry. Furthermore, even if f1 and f2 are the same fingerprint value, making it look like (p1,c) is still a valid entry, if (p1,c) has an older timestamp than (p2,c) the entry can be recognized as invalid. (This depends on the fact that in a cache that does not implement deduplication, only one primary storage location can be cached at any cache location.)

Reading a cached block: The data entry is read from the persistent cache and a new metadata entry with the updated usage statistics is appended to the meta-data journal, indicating that this block has been accessed again. For one embodiment, the validity of a cached block and its metadata entry are evaluated/determined when the cached block is read.

An alternative page replacement policy (not shown) that can be used to mostly sequentialize the writes to the cache is a variant of the clock replacement policy. As in the classic clock policy, a frequency count is associated with each block of the cache, indicating how often it has been used since being inserted. One of the parameters that can be used to tune the clock policy is a limit on how large this frequency count can be. For one embodiment, the limit is allowed to be quite large, at least 1 million. If a block is accessed more often than the limit before being evicted from the cache, the frequency count stays at this maximum regardless of any further accesses to this block.

A process similar to the classic clock policy rotates periodically through all the blocks in the cache, looking for a candidate block to evict. This process is activated each time a new block needs to be inserted into the cache. The process steps through the cache, looking for the first block it can find with a frequency count of zero. In the classic clock policy implementation, the process would subtract one from each non-zero frequency count it encounters. Eventually, after skipping over a block often enough, decrementing its frequency count each time, the block's frequency count will go to zero (if it is not used again in the meantime), allowing it to be evicted.

A variant of the classic clock policy of decrementing the frequency count provides a better approximation of the desirable LFU policy, while not affecting the sequentiality of the write operations. In the variant of the clock policy employed in this embodiment, each time the process passes over a block that has a non-zero frequency count, it decays this frequency count by a specified decay rate, which is a parameter of the method. For example, if the decay rate is d, a fraction between 0 and 1, and the non-zero frequency count is f, the process replaces the stored number f with (f*(1−d)) rounded down to the nearest integer.

This variant of the clock policy, has two parameters: a maximum frequency count, and a decay rate (between 0 and 1). For one embodiment, the maximum frequency count would be greater than one million and the decay rate would be somewhere between 0.2 and 0.6. Depending on the frequency distribution characteristics of the I/O requests, values in this range tend to approximate keeping the most frequently used 110 blocks in the cache. Furthermore, this variant of the clock policy results in roughly sequential writes to the flash cache, but with gaps where it skips over blocks that have been accessed frequently enough (and recently enough) to have a non-zero frequency count. It is believed that the flash transition layer (“FTL”) logic in most flash devices will recognize this mostly sequential behavior, resulting in good write performance, or at least better write performance than would be the case with completely random writes.

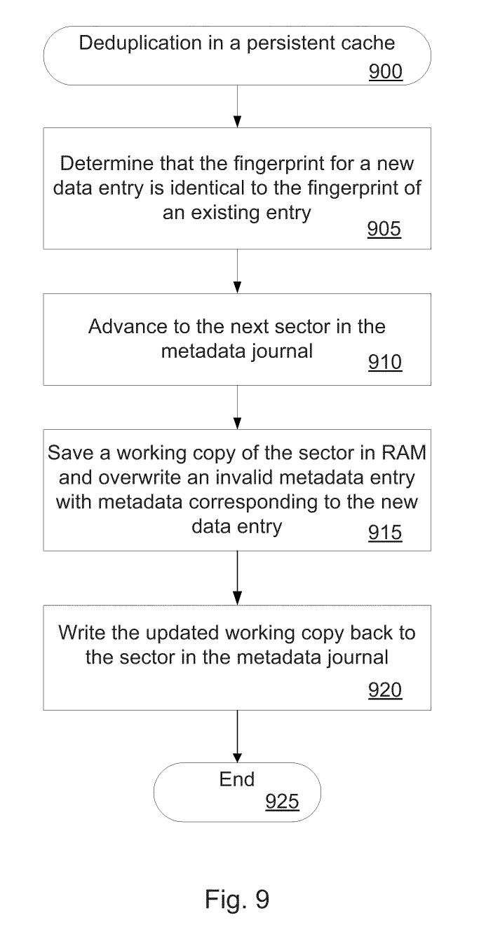

FIG. 9 shows an exemplary flow chart for a method 900 of employing deduplication in a persistent cache. Caching a new primary storage location at an existing location containing identical data happens under two different circumstances: (1) an uncached block of data is read from location p1 on the primary storage server, and discovered to be identical to one that is already cached from location p2; and (2) a newly written block of data that is a copy of primary storage location p1 is inserted into the cache and is discovered to be identical to one that is already cached as a copy of p2. In these cases, the metadata update is performed as described above, but no write is performed to insert the data block, since it is already in the cache.

For example, method 900 proceeds as follows. At block 905, the method 900 determines that a fingerprint for a new/non-cached data entry is identical to the fingerprint of an existing entry. At block 910, the method 900 advances to the next sector in the metadata journal 305. At block 915, the method 900 saves a working copy of the sector in RAM and overwrites an invalid metadata entry with the metadata corresponding to the new/non-cached data entry and the existing entry with the identical fingerprint. At block 920, the updated working copy is written back to the sector in the metadata journal 305.

For one embodiment, if the cached block represents more than one different primary storage address (it has been deduplicated), then a write operation does not overwrite the cached block. Instead, another block is chosen for eviction and replacement with the new data. This procedure is similar to the following description of replacing a cached block with a different block.

Unlike in the case of a non-deduplicating cache, there can be multiple different primary storage locations cached at the same cache location if they all have the same data contents. Therefore, when replacing a cached block that represents copies of p1 through pk with a cached copy of a different primary storage location pn, it is positively indicated in the meta-data journal that p1 through pk are no longer cached at c. Failure to do this would result in a situation where it might appear that p1 through pk are still cached at that location. This would happen, for example, if pn were later replaced by a block that has the same fingerprint as p1 through pk had at the time they were cached there. Thus, when a cached block is replaced with a different block, the procedure that is followed is exactly the same as for an eviction followed by caching a block in an empty location. First the metadata journal 305 is updated to indicate that p1 through pk are no longer in the cache. Then an entry is appended to the metadata journal 305 indicating that pn is now cached at location c. Of course, may be performed with a single write to the metadata journal 305, using the batching technique previously described. Otherwise, the other procedures remain the same as a non-deduplicating cache.

FIG. 10 shows an exemplary flow chart for a method 1000 for reconstructing a working cache or counterpart metadata entries in RAM from the persistent cache. The metadata and block data previously stored in the flash memory are used to reconstruct a working cache in RAM. At block 1005, the method 1000 reads each entry in the metadata journal 300. At block 1010, the method 1000 determines if the persistent cache employs deduplication. If deduplication is employed, at block 1015, the method 1000 selects a metadata entry for use in reconstruction, if there are two or more metadata entries associated with the same data location in primary storage 320, by examining their timestamps. The metadata entry with the most recent timestamp is used and the others are ignored and/or marked as invalid. At block 1020, if deduplication is not employed, the method 1000 selects a metadata entry for use in reconstruction, if there are two or more metadata entries associated with the same cache location in the persistent cache, by examining their timestamps. The metadata entry with the most recent timestamp is used and the others are ignored and/or marked as invalid. Alternatively, the process described with reference to block 1015 is used for both a deduplicating cache and non-deduplicating cache. For one embodiment, block 1010 is omitted and method 1000 proceeds directly to either block 1015 or block 1020.

Thus, a persistent cache is implemented in a computer system as described herein. In practice, the methods 500, 600, 700, 900, and 1000 each may constitute one or more programs made up of computer-executable instructions. The computer-executable instructions may be written in a computer programming language, e.g., software, or may be embodied in firmware logic or in hardware circuitry. The computer-executable instructions to implement a persistent cache may be stored on a machine-readable storage medium. A “computer-readable storage medium”, as the term is used herein, includes any mechanism that provides (i.e., stores and/or transmits) information in a form accessible by a machine (e.g., a computer, network device, personal digital assistant (PDA), manufacturing tool, any device with a set of one or more processors, etc.). The term RAM as used herein is intended to encompass all volatile storage media, such as dynamic random access memory (DRAM) and static RAM (SRAM). Computer-executable instructions can be stored on non-volatile storage devices, such as magnetic hard disk, an optical disk, and are typically written, by a direct memory access process, into RAM/memory during execution of software by a processor. One of skill in the art will immediately recognize that the terms “machine-readable storage medium” and “computer-readable storage medium” include any type of volatile or non-volatile storage device that is accessible by a processor. For example, a machine-readable storage medium includes recordable/non-recordable media (e.g., read-only memory (ROM); random access memory (RAM); magnetic disk storage media; optical storage media; flash memory devices; etc.).

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

Therefore, it is manifestly intended that this invention be limited only by the following claims and equivalents thereof.

What is claimed is:

1. A computerized method of implementing a cache in a memory, the method comprising:
writing, by the computer, new metadata to the memory by overwriting an invalid metadata entry with the new metadata, wherein overwriting the invalid metadata entry includes sequentially advancing to a next sector in the memory containing an invalid metadata entry and writing a fingerprint corresponding to a new data entry in place of the invalid metadata entry; and
writing, by the computer, the new data entry to the memory.

2. The computerized method of claim 1, wherein the memory includes a low frequency section and a high frequency section in which data entries are stored, wherein the computer writes to the low frequency section in a current location of a low frequency section pointer, wherein the computer writes to the high frequency section in a current location of a high frequency section pointer, and wherein the new data entry is written to the low frequency section by sequentially advancing the current location of the low frequency section pointer to a next location in the low frequency section and writing the new data entry to the current location of the low frequency section pointer.

3. The computerized method of claim 2, further comprising promoting a data entry stored in the low frequency section of the memory to the high frequency section of the memory by:
sequentially advancing a current location of the low frequency section pointer to a next location in the low frequency section;
copying the data entry at the current location of the low frequency section pointer to a non-persistent memory if the data entry at the current location of the low frequency section pointer is the data entry to be promoted;
sequentially advancing a current location of the high frequency section pointer to a next location in the high frequency section;
copying the data entry at the current location of the high frequency section pointer to the current location of the low frequency section pointer;
copying the data entry to be promoted to the current location of the high frequency section pointer.

4. The computerized method of claim 3, further comprising writing metadata corresponding to the promotion of the data entry by:
saving a working copy of the sector in the memory containing an invalid metadata entry in RAM;
writing metadata corresponding to the data entry copied from the high frequency section to the low frequency section to the working copy and writing metadata corresponding to the data entry promoted to the high frequency section to the working copy, wherein the writing the fingerprint corresponding to the new data entry in place of the invalid metadata entry is written to the working copy; and
overwriting the sector in the memory containing the invalid entry with the working copy of the sector containing the new metadata.

5. The computerized method of claim 1, wherein the invalid metadata entry is determined to be invalid by comparing the invalid metadata entry to a working copy of a corresponding entry in random access memory (“RAM”).

6. The computerized method of claim 1, wherein overwriting the invalid metadata entry further includes writing an address map corresponding to a location of the data entry in the cache and a location of the data entry in primary storage.

7. The computerized method of claim 1, further comprising:
reading a data entry of a cached block;
computing a fingerprint of the data entry of the cached block;
determining that the computed fingerprint and a fingerprint stored in a metadata entry associated with the cached block are different; and
updating the metadata entry associated with the cached block to be invalid.

8. The computerized method of claim 1, wherein writing new metadata includes overwriting a plurality of invalid metadata entries in a sector as a single, batch operation.

9. The computerized method of claim 1, wherein the metadata further includes a timestamp, the method further comprising:
reconstructing a non-persistent cache upon a reboot, wherein reconstructing the non-persistent cache includes reading each metadata entry in the memory, determining that two metadata entries are associated with a single cache location, and utilizing one of the two metadata entries that has a more recent timestamp than a timestamp of the other of the two metadata entries.

10. The computerized method of claim 1, wherein the metadata further includes a timestamp, the method further comprising:
reconstructing a non-persistent cache upon a reboot, wherein reconstructing the non-persistent cache includes reading each metadata entry in the memory, determining that two metadata entries are associated with a single location in primary storage, and utilizing one of the two metadata entries that has a more recent timestamp than the timestamp of the other of the two metadata entries.

11. The computerized method of claim 1, further comprising:
determining a number of valid metadata entries stored in the cache memory; and
adjusting a limit on a total number of metadata entries that can be stored in the cache memory to be a multiple of the number of valid metadata entries.

12. The computerized method of claim 1, wherein the memory is a flash memory.

13. A computerized method of implementing a cache in a memory, the method comprising:
determining that a fingerprint corresponding to a new data entry is identical to a fingerprint of an existing data entry in the memory; and
sequentially writing, by the computer, new metadata corresponding to the new data entry to the memory by overwriting an invalid metadata entry with the new metadata, wherein overwriting the invalid metadata entry includes
advancing to a next sector in the memory containing an invalid metadata entry,
saving a working copy of the sector in RAM,
writing new metadata, including the fingerprint corresponding to the new data entry and an address map corresponding to a cache location of the existing data entry, in place of the invalid metadata entry in the working copy of the sector in RAM, and
overwriting the sector in the memory containing the invalid entry with the working copy of the sector containing the new metadata.

14. The computerized method of claim 13, wherein writing new metadata includes overwriting a plurality of invalid metadata entries in the sector in a single, batch operation.

15. The computerized method of claim 13, wherein the metadata further includes a timestamp, the method further comprising:
reconstructing a non-persistent cache upon a reboot, wherein reconstructing the non-persistent cache includes reading each metadata entry in the memory, determining that two metadata entries are associated with a single location in primary storage, and utilizing one of the two metadata entries that has a more recent timestamp than the other of the two metadata entries.

16. The computerized method of claim 13, wherein the memory is a flash memory.

17. A computerized system comprising:
a memory;
a processor coupled to the memory through a bus, wherein the processor executes instructions that to cause the processor to
write new metadata to the memory by overwriting an invalid metadata entry with the new metadata, wherein overwriting the invalid metadata entry includes sequentially advancing to a next sector in the memory containing an invalid metadata entry and writing a fingerprint corresponding to a new data entry in place of the invalid metadata entry; and
write the new data entry to the memory.

18. The computerized system of claim 17, wherein the memory includes a low frequency section and a high frequency section in which data entries are stored, wherein the computer writes to the low frequency section in a current location of a low frequency section pointer, wherein the computer writes to the high frequency section in a current location of a high frequency section pointer, and wherein the new data entry is written to the low frequency section by sequentially advancing the current location of the low frequency section pointer to a next location in the low frequency section and writing the new data entry to the current location of the low frequency section pointer.

19. The computerized system of claim 18, wherein the instructions further cause the processor to promote a data entry stored in the low frequency section of the memory to the high frequency section of the memory by:
sequentially advancing a current location of the low frequency section pointer to a next location in the low frequency section;
copying the data entry at the current location of the low frequency section pointer to RAM if the data entry at the current location of the low frequency section pointer is the data entry to be promoted;
sequentially advancing a current location of the high frequency section pointer to a next location in the high frequency section;
copying the data entry at the current location of the high frequency section pointer to the current location of the low frequency section pointer;
copying the data entry to be promoted to the current location of the high frequency section pointer.

20. The computerized system of claim 19, wherein the instructions further cause the processor to write metadata corresponding to the promotion of the data entry by:
saving a working copy of the sector in the memory containing an invalid metadata entry in RAM;
writing metadata corresponding to the data entry copied from the high frequency section to the low frequency section to the working copy and writing metadata corresponding to the data entry promoted to the high frequency section to the working copy, wherein the writing the fingerprint corresponding to the new data entry in place of the invalid metadata entry is written to the working copy; and
overwriting the sector in the memory containing the invalid entry with the working copy of the sector containing the new metadata.

21. The computerized system of claim 17, wherein the invalid metadata entry is determined to be invalid by comparing the invalid metadata entry to a working copy of a corresponding entry in RAM.

22. The computerized system of claim 17, wherein overwriting the invalid metadata entry further includes writing an address map corresponding to a location of the data entry in the cache and a location of the data entry in primary storage.

23. The computerized system of claim 17, wherein the instructions further cause the processor to:
read a data entry of a cached block;
compute a fingerprint of the data entry of the cached block;
determine that the computed fingerprint and a fingerprint stored in a metadata entry associated with the cached block are different; and
update the metadata entry associated with the cached block to be invalid.

24. The computerized system of claim 17, wherein writing new metadata includes overwriting a plurality of invalid metadata entries in a sector as a single, batch operation.

25. The computerized system of claim 17, wherein the metadata further includes a timestamp and wherein the instructions further cause the processor to:
reconstruct a non-persistent cache upon a reboot, wherein reconstructing the non-persistent cache includes reading each metadata entry in the memory, determining that two metadata entries are associated with a single cache location, and utilizing one of the two metadata entries that has a more recent timestamp than a timestamp of the other of the two metadata entries.

26. The computerized system of claim 17, wherein the metadata further includes a timestamp and wherein the instructions further cause the processor to:
reconstructing a non-persistent cache upon a reboot, wherein reconstructing the non-persistent cache includes reading each metadata entry in the memory, determining that two metadata entries are associated with a single location in primary storage, and utilizing one of the two metadata entries that has a more recent timestamp than the timestamp of the other of the two metadata entries.

27. The computerized system of claim 17, wherein the instructions further cause the processor to:
determining a number of valid metadata entries stored in the cache memory; and
adjusting a limit on a total number of metadata entries that can be stored in the cache memory to be a multiple of the number of valid metadata entries.

28. A computerized system comprising:
a memory; and
a processor coupled to the memory through a bus, wherein the processor executes instructions that to cause the processor to
determine a fingerprint corresponding to a new data entry is identical to a fingerprint of an existing data entry in the memory; and
sequentially write new metadata corresponding to the new data entry to the memory by overwriting an invalid metadata entry with the new metadata, wherein overwriting the invalid metadata entry includes
advancing to a next sector in the memory containing an invalid metadata entry,
saving a working copy of the sector in RAM,
writing new metadata, including the fingerprint corresponding to the new data entry and an address map corresponding to a cache location of the existing data entry, in place of the invalid metadata entry in the working copy of the sector in RAM, and
overwriting the sector in the memory containing the invalid entry with the working copy of the sector containing the new metadata.

29. The computerized system of claim 28, wherein writing new metadata includes overwriting a plurality of invalid metadata entries in the sector in a single, batch operation.

30. The computerized system of claim 28, wherein the metadata further includes a timestamp and wherein the instructions further cause the processor to:
reconstructing a non-persistent cache upon a reboot, wherein reconstructing the non-persistent cache includes reading each metadata entry in the memory, determining that two metadata entries are associated with a single location in primary storage, and utilizing one of the two metadata entries that has a more recent timestamp than the other of the two metadata entries.

31. A computer readable storage medium storing executable instructions which, when executed by a processor, cause the processor to perform operations comprising:
writing new metadata to the flash memory by overwriting an invalid metadata entry with the new metadata, wherein overwriting the invalid metadata entry includes
sequentially advancing to a next sector in the flash memory containing an invalid metadata entry,
saving a working copy of the sector in the flash memory containing an invalid metadata entry in RAM,
writing a fingerprint corresponding to a new data entry in place of the invalid metadata entry in the working copy, and
overwriting the sector in the flash memory containing the invalid entry with the working copy of the sector containing the new metadata;
writing the new data entry to the flash memory, wherein the flash memory includes a low frequency section and a high frequency section in which data entries are stored, wherein the computer writes to the low frequency section in a current location of a low frequency section pointer, wherein the computer writes to the high frequency section in a current location of a high frequency section pointer, and wherein the new data entry is written to the low frequency section by sequentially advancing the current location of the low frequency section pointer to a next location in the low frequency section and writing the new data entry to the current location of the low frequency section pointer; and
reconstructing a non-persistent cache upon a reboot, wherein reconstructing the non-persistent cache includes
reading each metadata entry in the flash memory, wherein each metadata entry includes a timestamp,
determining that two metadata entries are associated with a single location in primary storage, and
utilizing one of the two metadata entries that has a more recent timestamp than the timestamp of the other of the two metadata entries.

32. A computer readable storage medium storing executable instructions which, when executed by a processor, cause the processor to perform operations comprising:
determining that a fingerprint corresponding to a new data entry is identical to a fingerprint of an existing data entry in the flash memory;
sequentially writing new metadata corresponding to the new data entry to the flash memory by overwriting an invalid metadata entry with the new metadata, wherein overwriting the invalid metadata entry is performed without writing the new data entry and includes
advancing to a next sector in the flash memory containing an invalid metadata entry,
saving a working copy of the sector in RAM,
writing new metadata, including the fingerprint corresponding to the new data entry and an address map corresponding to a cache location of the existing data entry, in place of the invalid metadata entry in the working copy of the sector in RAM, and
overwriting the sector in the flash memory containing the invalid entry with the working copy of the sector containing the new metadata; and
reconstructing a non-persistent cache upon a reboot, wherein reconstructing the non-persistent cache includes
reading each metadata entry in the flash memory, wherein each metadata entry includes a timestamp,
determining that two metadata entries are associated with a single location in primary storage, and
utilizing one of the two metadata entries that has a more recent timestamp than the timestamp of the other of the two metadata entries.
